(19) United States
(12) Patent Application Publication
(10) Pub. No.: US 2010/0315730 A1
(43) Pub. Date: Dec. 16, 2010

(54) Lens-Driving Unit

(75) Inventor: Yoshio Kakuta, Saitama-shi (JP)

Correspondence Address: THE WEBB LAW FIRM, P.C., 700 KOPPERS BUILDING, 436 SEVENTH AVENUE, PITTSBURGH, PA, 15219, US

(73) Assignee: TAMRON CO., LTD., Saitama-shi (JP)

(21) Appl. No.: 12/521,458

(22) PCT Filed: Dec. 25, 2007
(86) PCT No.: PCT/JP2007/074867

§ 371 Date: Sep. 9, 2009

(30) Foreign Application Priority Data
Dec. 28, 2006 (JP) 2006-356052

(51) Int. Cl. G02B 7/04

(52) U.S. Cl. 359/824

(57) ABSTRACT

Provided is a lens driving device reduced in sizes. In a right side region divided by a virtual center line vertically passing the outer circumference region of both lens group holding frames, including an optical axis, a lens driving device concentratedly has a first guide pole, a second guide pole, a lead screw of a first piezoelectric motor, and a lead screw of a second piezoelectric motor, when viewed from the front. Furthermore, the lead screw of the first piezoelectric motor and the lead screw of the second piezoelectric motor are arranged in an intermediate region between the first guide pole and the second guide pole.

### TECHNICAL FIELD

The present invention relates to a lens-driving unit for driving two lens-group holding frames constituting an imaging device respectively.

### BACKGROUND ART

Conventionally, a mechanism in which two lens-groups (the first lens group and the second lens group) are made move in an optical axis direction is usually applied for an optical zooming system in a digital camera. The two lens-groups are held by the first lens-group holding frame and the second lens-group holding frame respectively. These lens-groups are arranged in series in the optical axis direction.

A lens-driving unit is used to make slide the first lens-group holding frame and the second lens-group holding frame in the optical axis direction respectively. As for a lens-driving unit, the lens-driving units proposed in Patent Document 1 and Patent Document 2 can be exemplified. The lens-driving units comprise two guide poles (the first guide pole and the second guide pole) and two piezo-electric motors (the first piezo-electric motor and the second piezo-electric motor).

In such a construction, the first guide pole and the first piezo-electric motor are utilized to make slide the first lens-group holding frame in the optical axis direction. The first guide pole is arranged to be parallel to the optical axis and supports the first lens-group holding frame able to move in the optical axis direction.

In addition, the first piezo-electric motor is composed of a lead screw, a nut geared with the lead screw and a piezo-element. The lead screw is arranged to be parallel to the optical axis and geared to the cam on the first lens-group holding frame. As a result, the first lens-group holding frame is arranged able to slide along the first guide pole in the optical axis direction when driven by the first piezo-electric motor.

Also, the second guide pole and the second piezo-electric motor are utilized to make slide the second lens-group holding frame in the optical axis direction. The second guide pole is arranged to be parallel to the optical axis and constructed to support the second lens-group holding frame able to move in the optical axis direction.

In addition, the second piezo-electric motor is composed of a lead screw, a nut and a piezo-element. The lead screw is arranged to be parallel to the optical axis and geared to the cam on the second lens-group holding frame. As a result, the second lens-group holding frame is arranged able to slide along the second guide pole in the optical axis direction when driven by the second piezo-electric motor.

However, in the front view of the lens-group holding frames in the lens-driving unit disclosed in Patent Document 1, the second guide pole is arranged in the periphery region thereof opposing to the three other devices (the first guide pole, the lead screw of the first piezo-electric motor and the lead screw of the second piezo-electric motor). As a result, the lens-driving unit is required to secure installation space for the four devices over the entire periphery region. As a result, the size of the lens-driving unit is made bigger.

On the other hand, in the lens-driving unit disclosed in Patent Document 2, the second guide pole is arranged in the space not separated from the three other devices in the periphery regions locating outside of the lens-group holding frames. As a result, space for installation of the four devices is reduced in the lens-driving unit compared to the lens unit disclosed in Patent Document 1.

[Patent Document 1] Japanese Patent Laid-Open No. 2006-98576

[Patent Document 2] Japanese Patent Laid-Open No. 2005-98575

### DISCLOSURE OF THE INVENTION

### Problems to be Solved by the Invention

However, the space for installation of the lens-driving unit comprising the four devices disclosed in Patent Document 2 requires allowance in the periphery regions locating outside of the lens-group holding frames. As a result, the lens-driving unit cannot satisfy requirement for miniaturization of imaging devices in recent years.

The present invention has been accomplished in view of the above described problems in conventional technologies, and an object of the present invention is to provide a lens-driving unit which enables an imaging device more compact.

### Means to Solve the Problems

Thus, the present inventors have made serious effort in investigations, and adopted the following lens-driving unit to solve the above described problems.

The lens-driving unit of the present invention is a lens-driving unit to make slide a first lens-group holding frame and a second lens-group holding frame constituting an imaging device arranged in series in an optical axis direction along a first guide pole and a second guide pole in the optical axis direction by using a first motor and a second motor respectively, wherein both the first guide pole and the second guide pole are arranged to be parallel to the optical axis to support the first lens-group holding frame and the second lens-group holding frame able to slide in the optical axis direction respectively, the first motor and the second motor comprise a lead device to make move the first lens-group holding frame and the second lens-group holding frame in the optical axis direction respectively and a piezo-element arranged on the lead device, a first holding unit is arranged on a periphery of the first lens-group holding frame and the lead device constituting the first motor fixed to the first holding unit is arranged to be parallel to the optical axis, the first lens-group holding frame is constructed able to slide along the first guide pole in the optical axis direction according to motion of the first holding unit in the optical axis direction driven by the first motor, a second holding unit is arranged on a periphery of the second lens-group holding frame and the lead device constituting the second motor fixed to the second holding unit is arranged to be parallel to the optical axis, the second lens-group holding frame is constructed able to slide along the second guide pole in the optical axis direction according to motion of the second holding unit in the optical axis direction driven by the second motor, and in the front view of the first lens-group holding frame and the second lens-group holding frame, when the periphery region of the first lens-group holding frame and the second lens-group holding frame is divided into the regions by a virtual center line vertically passing through the periphery region including the optical axis, the lead device constituting the first motor, the lead device constituting the second motor, the first guide pole and the second guide pole are gathered in one side of the regions.

In such a construction of the lens-driving unit of the present invention, the two sets of motor and guide pole are gathered in the one region, devices comprising same functions can be arranged close to each other when compared to a construction in which devices comprising same functions are arranged apart from each other and it enables the device arrangement more compact than the device arrangement comprising a conventional construction.

In addition, in the lens-driving unit of the present invention, the first motor is a first piezo-electric motor and the second motor is a second piezo-electric motor, the first piezo-electric motor and the second piezo-electric motor are composed of a lead screw, a nut geared with the lead screw and a piezo-element arranged on a periphery of the nut, and the lead device is composed of the lead screw and the nut, the first holding unit is a first piezo-electric motor holding unit and the second holding unit is a second piezo-electric motor holding unit, the nut of the first piezo-electric motor is fixed to the first piezo-electric motor holding unit via the piezo-elements in the state that the lead screw of the first piezo-electric motor is arranged to be parallel to the optical axis, and the nut of the second piezo-electric motor is fixed to the second piezo-electric motor holding unit via the piezo-elements in the state that the lead screw of the second piezo-electric motor is arranged to be parallel to the optical axis.

Also in such a construction of the lens-driving unit of the present invention, the two sets of motors and guide poles are gathered in the one region, when compared to a construction in which devices comprising same functions are arranged apart from each other, it enables the device arrangement more compact than the device comprising a conventional construction.

In addition, in the lens-driving unit of the present invention, in the front view of the first lens-group holding frame and the second lens-group holding frame, the first guide pole and the second guide pole are arranged at positions on a circumferential orbit of a virtual circle which is virtually set centered on the optical axis around the periphery of the first lens-group holding frame and the second lens-group holding frame where the diagonals of a virtual rectangle whose top line and bottom line intersects the virtual line at right angle and is inscribed in the virtual circle intersect, and the lead screw of the first piezo-electric motor and the lead screw of the second piezo-electric motor are arranged in a central area between the first guide pole and the second guide pole.

In such a construction of the lens-driving unit of the present invention, the lead screws are arranged in a central area between the two guide poles arranged on the circumferential orbit of the virtual circle, it enables to save the space required for four devices when compared to a construction in which the lead screws are not arranged in a central area between the two guide poles.

In addition, in the lens-driving unit of the present invention, the lead screw of the first piezo-electric motor and the lead screw of the second piezo-electric motor are arranged on the circumferential orbit of the virtual circle.

Because of such a construction, the lens-driving unit of the present invention enables the four devices to be arranged close to each other in the vicinity of the lens-group holding frames, un-useful spaces can be reduced.

In the lens-driving unit of the present invention, a rotation prevention pole is arranged to be parallel to the optical axis and common for the first lens-group holding frame and the second lens-group holding frame is disposed in the region other than the region for the first lens-group holding frame and the second lens-group holding frame in the regions resulted from dividing the periphery region by the virtual center line in the front view of the first lens-group holding frame and the second lens-group holding frame.

Because of such a construction, as the lens-driving unit of the present invention drives the lens-group holding frames without rotation, smooth action of the lens-group holding frames can be achieved.

### ADVANTAGES OF THE INVENTION

In the lens-driving unit of the present invention, because the two sets of the motors and the guide poles are gathered in the one region, it enables the device arrangement more compact than the device arrangement composed of a conventional construction in which the devices comprising same functions are arranged apart from each other. It means that the lens-driving unit of the present invention is suitable for miniaturization.

In addition, the lens-driving unit of the present invention may utilize a piezo-electric motor for the motor. The lens-driving unit of the present invention is made more compact than the conventional construction in such a case also. It means that the lens-driving unit of the present invention is suitable for miniaturization.

Further, in the lens-driving unit of the present invention, the two guide poles are arranged at positions on the circumferential orbit of a virtual circle, two guide poles are arranged at positions on a circumferential orbit of a virtual circle which is virtually set centered on the optical axis, and the lead screws are arranged in the central area between the two guide poles. As a result, reduction of the installation space for the four devices is performed when compared to the case where the lead screws are not arranged between the guide poles. It means that the lens-driving unit of the present invention is suitable for further miniaturization.

Next, in the lens-driving unit of the present invention, the lead screws are arranged on the circumferential orbit of a virtual circle. As a result, in the lens-driving unit of the present invention, the four devices can be arranged close to each other in the vicinity of the lens-group holding frames to enable reduction of un-useful spaces. It means that the lens-driving unit is suitable for further miniaturization.

In addition, in the lens-driving unit of the present invention, a rotation prevention pole for the lens-group holding frame is arranged in the other regions in the periphery region of the lens-group holding frames. According to the arrangement, the lens-driving unit of the present invention can drive the lens-group holding frames without rotation to result smooth action of the lens-group holding frames. It means that the lens-driving unit of the present invention enables excellent action of the lens-group holding frames.

### BEST MODE FOR CARRYING OUT THE INVENTION

Hereinafter, embodiments of the present invention will be demonstrated with reference to the accompanying drawings.

### First Embodiment

FIG. 1 is the outline view of a mobile phone 101 showing the first embodiment of the present invention. The mobile phone 101 is a mobile phone comprising a camera function and provided with the camera module 102. The camera module 102 comprises the box-shaped case 110, a lens unit arranged in the case 110 and an image sensor (CCD). The camera module 102 is constructed to make the image sensor detect the light reflecting an image from an object according to an operator's instruction. And then the image information is converted to an electric signal and output the electric signal to an A/D converter or the like.

FIG. 2 is a perspective view of a lens unit 10. The lens unit 10 comprises the first lens-group holding frame 11, the second lens-group holding frame 12 and the lens-driving unit 1.

The first lens-group holding frame 11 and the second lens-group holding frame 12 are arranged in series along the optical axis L. The first lens-group holding frame 11 is arranged in the front side (object side). The first lens-group holding frame 11 is constructed to hold a first lens group (not shown) therein.

In addition, the first guide part 13 is connected to the periphery region 111 locating outside of the first lens-group holding frame 11. The first guide part 13 is formed in a cylindrical shape and is arranged to be parallel to the optical axis L. In the view from the front (object side) as shown in FIG. 3, the first guide part 13 is arranged in central area of the right bottom region 111a resulting from quartering the periphery region 111 by virtual center lines X that pass through the optical axis L vertically and Y that pass through the optical axis L horizontally.

Specifically, the first guide part 13 is arranged at a position on the circumferential orbit B1a of the first virtual circle B1 where one diagonal C1 of the virtual rectangle C intersects. Here, “the first virtual circle 31” is a circle virtually set centered on the optical axis L around the periphery of the lens-group holding frames 11 and 12. In addition, the virtual rectangle C is a rectangle inscribed in the first virtual circle B1 comprising top and bottom lines intersecting the virtual line X at right angle. The virtual rectangle C has a square or rectangular shape. The shape of the virtual rectangle C of the present embodiment is substantially square.

In addition, as shown in FIG. 2, the first lens-group holding frame 11 comprises the first rotation prevention pole container 112. The first rotation prevention pole container 112 is U-shaped in the view from the object side (or focusing side). The first rotation prevention pole container 112 is arranged in central area of the left top region 111b resulting from quartering the periphery region 111 by the virtual center lines X and Y as shown in FIG. 3.

On the other hand, as shown in FIG. 2, the second lens-group holding frame 12 is arranged on a back side (focusing side). The second lens-group holding frame 12 is constructed to hold a second lens group (not shown) therein.

In addition, a support part 14 is connected to the back side (focusing side) of the second lens-group holding frame 12. The support part 14 is a part that supports the second lens-group holding frame 12 to arrange the second lens-group holding frame 12 in series to the first lens-group holding frame 11.

Further, the second guide part 15 is connected to the support part 14. The second guide part 15 is formed in a cylindrical shape and is arranged to be parallel to the optical axis L. In the front view shown in FIG. 3, the second guide part 15 is arranged to face the first guide part 13 in the vertical direction across a right side region 11a of the first lens-group holding frame 11.

Specifically, the second guide part 15 is arranged close to a central area of the right top region 111c resulting from quartering the periphery region 111 locating outside of the first lens-group holding frame 11 by the virtual center lines X and Y. In other words, the second guide part 15 is arranged at a position on the circumferential orbit B1a of the first virtual circle B1 intersects another diagonal C2 of the virtual rectangle C.

In addition, as shown in FIG. 2, the support part 14 comprises the second rotation prevention pole container 142. The second rotation prevention pole container 142 is U-shaped in the view from the object side (or focusing side). The second rotation prevention pole container 142 is arranged to face to the first rotation prevention pole container 112 in the optical axis direction A.

The lens-driving unit 1 drives the first lens-group holding frame 11 and the second lens-group holding frame 12 respectively. The lens-driving unit 1 comprises the first lens-group holding frame driving device 2, the second lens-group holding frame driving device 3, the rotation prevention pole 4, the first lens-group holding frame moving distance measuring device 5 and the second lens-group holding frame moving distance measuring device 6.

The rotation prevention pole 4 is a part to prevent rotation of the lens-group holding frames 11 and 12 when the lens-group holding frames 11 and 12 are made slide in an optical axis direction A. The rotation prevention pole 4 is furnished in the rotation prevention pole containers 112 and 142 of the lens-group holding frames 11 and 12.

In addition, the first lens-group holding frame moving distance measuring device 5 is an apparatus that measures the moving distance of the first lens-group holding frame 11. Also, the second lens-group holding frame moving distance measuring device 6 is an apparatus that measures the moving distance of the second lens-group holding frame 12.

The first lens-group holding frame driving device 2 is an apparatus that drives the first lens-group holding frame 11. The first lens-group holding frame driving device 2 comprises the first guide pole 20, the first drive mean 21 and the first flexible printed wiring board 22.

The first guide pole 20 is a part that supports the first lens-group holding frame 11 able to move in the optical axis direction A. The first guide pole 20 is formed in a long round bar shape. The first guide pole 20 is inserted into the first guide part 13 and is arranged to be parallel to the optical axis L. The spring 20a is set on the first guide pole 20 closer to the object side than the first guide part 13. The spring 20a is set to push the first lens-group holding frame 11 always toward the focusing side.

On the other hand, the first drive mean 21 comprises the first piezo-electric motor 23 and the first piezo-electric motor holding unit 24. The first piezo-electric motor 23 comprises one lead screw 231, one nut 232 and four piezo-elements 233.

The lead screw 231 is arranged to be parallel to the optical axis L. In addition, the nut 232 is geared with the lead screw 231. Further, the four piezo-elements 233 are arranged on the periphery of the nut 232.

In addition, the first piezo-electric motor holding unit 24 is the apparatus that makes move the first lens-group holding frame 11 by using a drive force generated by the first piezo-electric motor 23. The first piezo-electric motor holding unit 24 is connected to the upper side (above the first guide part 13) of the right bottom region 111a in the periphery region 111 locating outside of the first lens-group holding frame 11 as shown in FIG. 3.

The first piezo-electric motor holding unit 24 is formed to be long in the optical axis direction A. In addition, the first piezo-electric motor holding unit 24 is formed to comprise concave surface in the view from the object side (or focusing side). The first piezo-electric motor 23 is disposed in the first piezo-electric motor holding unit 24. Specifically, the nut 232 is fixed to the inner wall surface 24a of the first piezo-electric motor holding unit 24 via each piezo-element 233 of the first piezo-electric motor 23.

In addition, in the front view of the first piezo-electric motor holding unit 24 connected to the first lens-group holding frame 11, it is constructed to be that the lead screw 231 of the first piezo-electric motor 23 is disposed on the circumferential orbit B2a of the second virtual circle B2 as shown in FIG. 3. Here, “the second virtual circle B2” refers to a circle virtually set centered on the optical axis L and locating outside of the first virtual circle B1 around the periphery of the lens-group holding frames 11 and 12.

Further, as shown in FIG. 2, the first flexible printed wiring board 22 supplies drive power and a control signal to the first piezo-electric motor 23. A terminal area on one end side of the first flexible printed wiring board 22 is connected to the first piezo-electric motor 23 and the other end side is connected to a unit for power supply and control (not shown).

Next, the method for driving the first lens-group holding frame 11 by the first lens-group holding frame driving device 2 will be demonstrated. First, drive power and a control signal are supplied from the unit for power supply and control to each piezo-element 233 via the first flexible printed wiring board 22. It results vibration in each piezo-element 233 and makes the lead screw 231 rotate to the direction clockwise or counterclockwise. The rotation of the lead screw 231 makes move the nut 232 along the lead screw 231. As a result, the first piezo-electric motor holding unit 24 is made move in the optical axis direction A and the first lens-group holding frame 11 is made slide along the first guide pole 20 in the optical axis direction A.

On the other hand, the second lens-group holding frame driving device 3 is an apparatus that drives the second lens-group holding frame 12. The second lens-group holding frame driving device 3 comprises the second guide pole 30, the second drive means 31 and the second flexible printed wiring board 32.

The second guide pole 30 is a part that supports the second lens-group holding frame 12 able to move in the optical axis direction A. The second guide pole 30 is formed in a long round bar shape. The second guide pole 30 is inserted into the second guide part 15 and is arranged to be parallel to the optical axis L. In addition, the spring 30a is set on the second guide pole 30 closer to the focusing side than the second guide part 13. The spring 30a is set to push the second lens-group holding frame 12 always toward the object side.

On the other hand, the second drive mean 31 comprises the second piezo-electric motor 33 and the second piezo-electric motor holding unit 34. The second piezo-electric motor 33 comprises one lead screw 331, one nut 332 and four piezo-elements 333.

The lead screw 331 is arranged to be parallel to the optical axis L. In addition, the nut 332 is geared with the lead screw 331. Further, the four piezo-elements 333 are arranged on the periphery of the nut 332.

In addition, the second piezo-electric motor holding unit 34 is the apparatus that makes move the second lens-group holding frame 12 by using a drive force generated by the second piezo-electric motor 33. The second piezo-electric motor holding unit 34 is connected at the position under the second guide part 15 as shown in FIG. 3.

Next, the second piezo-electric motor holding unit 34 is formed to be long in the optical axis direction A as shown in FIG. 2. In addition, the second piezo-electric motor holding unit 34 is formed to comprise concave surface in the view from the object side (or focusing side). The second piezo-electric motor 33 is disposed in the second piezo-electric motor holding unit 34. Specifically, the nut 332 is fixed to the inner wall surface 34a of the second piezo-electric motor holding unit 34 via each piezo-element 333 of the second piezo-electric motor 33.

In addition, in the front view of the second piezo-electric motor holding unit 34 connected at the position under the second guide part 15, it is constructed to be that the lead screw 331 of the second piezo-electric motor 33 is deposed at the position upper than lead screw 231 of the first piezo-electric motor 23 on the circumferential orbit B2a of the second virtual circle B2 as shown in FIG. 3.

Further, the second flexible printed wiring board 32 supplies a control signal and drive power to the second piezo-electric motor 33. In the second flexible printed wiring board 32, a terminal area on one end side is connected to the second piezo-electric motor 33 and the other end side is connected to the unit for power supply and control (not shown).

Next, the method for driving the second lens-group holding frame 12 by the second lens-group holding frame driving device 3 will be demonstrated. First, drive power and a control signal are supplied from the unit for power supply and control to each piezo-element 333 via the second flexible printed wiring board 32. It results vibration in each piezo-element 333 and make the lead screw 331 rotate to the direction clockwise or counterclockwise. The rotation of the lead screw 331 makes move the nut 332 along the lead screw 331. As a result, the second piezo-electric motor holding unit 34 is made move in the optical axis direction A and the second lens-group holding frame 12 is made slide along the second guide pole 30 in the optical axis direction A.

In the construction described above, the lens-driving unit 1 of the present embodiment in the front view shown in FIG. 3, the four devices 20, 30, 231 and 331 are arranged in a right side region Sa resulting from dividing the periphery region of the lens-group holding frames 11 and 12 by the virtual center line X. Specifically, the four devices 20, 30, 231 and 331 are gathered in the vicinity of the right side region of a transition trail T (see FIG. 1) of the lens-group holding frames 11 and 12, in order of the second guide pole 30, the second lead screw 331, the first lead screw 231 and the first guide pole 20 from the top.

The “periphery region” of the lens-group holding frames 11 and 12 refers to a region which locates outside to the periphery of the transition trail T of the lens-group holding frames 11 and 12. Where, the transition trail T is a cylindrical trail where the first lens-group holding frame 11 and the second lens-group holding frame 12 move along the optical axis L.

Because the four devices 20, 30, 231 and 331 are gathered at the right side region Sa, when compared to a construction in which devices comprising same functions are arranged apart from each other, it enables the device arrangement more compact than the devices arrangement comprising a conventional construction. That is, the lens-driving unit 1 of the present embodiment enables reduction of the installation space for the four devices 20, 30, 231 and 331 when compared to the conventional lens-driving unit. It means that the lens-driving unit 1 of the present embodiment is suitable for miniaturization.

In addition, in the lens-driving unit 1 of the present embodiment, the two guide poles 20 and 30 are arranged at positions on the circumferential orbit Bla of the first virtual circle B1 where the diagonals C1 and C2 of the virtual rectangle C intersect, and the lead screws 231 and 331 are arranged in the central area (space) between the guide poles 20 and 30. As a result, the lens-driving unit 1 of the present embodiment can reduce the installation space for the four devices 20, 30, 231 and 331 when compared to the case where the lead screws 231 and 331 are not arranged between the guide poles 20 and 30. It means that the lens-driving unit 1 of the present embodiment is suitable for further miniaturization.

Further, in the lens-driving unit 1 of the present embodiment, the lead screw 231 of the first piezo-electric motor 23 is arranged in the first guide pole 20 side and the lead screw 331 of the second piezo-electric motor 33 is arranged in the second guide pole 30 side, in the above described central area.

As described above, in the lens-driving unit 1 of the present embodiment, the piezo-electric motor holding units 24 and 34 are arranged in the same region to the corresponding guide pole 20 and 30. It means that the lens-driving unit 1 of the present embodiment can transmit the drive forces generated by the piezo-electric motor holding units 24 and 34 along the corresponding guide poles 20 and 30 more easily when compared to the case where the piezo-electric motor holding units 24 and 34 are arranged opposed to the guide poles 20 and 30. As a result, the lens-driving unit 1 of the present embodiment can make move the lens-group holding frames 11 and 12 to an accurate position in a short time. It means that, according to the lens-driving unit 1 of the present embodiment, the drive performance of the lens-group holding frames 11 and 12 can be improved.

In addition, in the lens-driving unit 1 of the present embodiment, when the lens-group holding frames 11 and 12 are viewed from the front, the lead screws 231 and 331 are arranged on the circumferential orbit B2a of the second virtual circle B2, as shown in FIG. 3. As a result, the lens-driving unit 1 of the present embodiment enables the lead screws 231 and 331 arrange close to each other in the vicinity of the lens-group holding frames 11 and 12. The arrangement enables to reduce unnecessary spaces. It means that the lens-driving unit 1 of the present embodiment is suitable for further miniaturization.

Further, in the lens-driving unit 1 of the present embodiment, when the lens-group holding frames 11 and 12 are viewed from the front, the rotation prevention pole 4 is arranged in the left side region Sb resulting from dividing the periphery region of the lens-group holding frames 11 and 12 by the virtual center line X, as shown in FIG. 3. As a result, the lens-driving unit 1 of the present embodiment can drive the lens-group holding frames 11 and 12 without rotation. As a result, the lens-driving unit 1 of the present embodiment can make move the lens-group holding frames 11 and 12 smoothly. It means that, according to the lens-driving unit 1 of the present embodiment, the drive performance of the lens-group holding frames 11 and 12 can be improved.

Next, the lens-driving unit 1 of the present embodiment is suitable for miniaturization of the camera module 102 (see FIG. 1). In addition, the mobile phone 101 of the present embodiment comprising the camera module 102 can realize miniaturization (thickness reduction) when compared to a mobile phone comprising a conventional camera module (lens-driving unit).

### Second Embodiment

FIG. 4 is a front view of a lens unit 500 showing the second embodiment of the present invention. In the present embodiment, same symbols for reference are assigned to the constituent common with the lens unit 10 of the first embodiment, and demonstration will be focused on different constituents.

The lens unit 500 of the present embodiment constitutes a camera module of a mobile phone in the case of the lens unit 10 demonstrated in the first embodiment. Main constituents of the lens unit 500 are the first lens-group holding frame 11, the second lens-group holding frame 12 and the lens-driving unit 601.

In addition, the lens-driving unit 601 comprises the first lens-group holding frame driving device 602, the second lens-group holding frame driving device 603 and the rotation prevention pole 4. The basic constructions of the lens-group holding frame driving devices 602 and 603 are the same as those of the lens-group holding frame driving devices 2 and 3 of the first embodiment.

In the lens-driving unit 601 of the present embodiment, when the lens-group holding frames 11 and 12 are viewed from the front, the guide poles 20 and 30 and the lead screws 231 and 331 constituting the first piezo-electric motor holding unit 624 and the second piezo-electric motor holding unit 634 are arranged on the circumferential orbit B1a of the first virtual circle B1. By the way in the FIG. 4, drawings of the nut and the piezo-element constituting both the first piezo-electric motor 23 and the second piezo-electric motor 33 are omitted.

As described above, in the lens-driving unit 601 of the present embodiment, all of the four devices 20, 30, 231 and 331 is arranged on the circumferential orbit B1a of the first virtual circle B1. As a result, the four devices 20, 30, 231 and 331 in the lens-driving unit 601 of the present embodiment are arranged close to each other in the vicinity of the lens-group holding frames 11 and 12. The arrangement enables to reduce unnecessary spaces. It means that the lens-driving unit 601 of the present embodiment is suitable for further miniaturization when compared to the lens-driving unit 1 of the first embodiment. In addition, the lens-driving unit 601 of the present embodiment can also achieve the effects which the lens-driving unit 1 of the first embodiment can achieve.

In the lens-driving unit 1 of the first embodiment and the lens-driving unit 601 of the second embodiment, the lens-group holding frames 11 and 12 are arranged in the region Sa which is the right side of the virtual center line X, but the region Sb which is the left side of the virtual center line X of the periphery region may also acceptable. Accordingly, the rotation prevention pole 4 may be arranged in the right side region Sa.

The first embodiment and the second embodiment demonstrate the lens-driving unit of the present invention installed in a mobile phone, but the lens-driving unit of the present invention may also be applied to other imaging devices such as a digital camera. It means that the lens-driving unit of the present invention is particularly suitable for use in an imaging device having a limited installation space for the lens-driving unit.

### INDUSTRIAL APPLICABILITY

As has been demonstrated above, the lens-driving unit of the present invention is suitable for miniaturization. As a result, the present invention can sufficiently be utilized in the technical field of lens-driving unites.

### BRIEF DESCRIPTION OF THE DRAWINGS

FIG. 1 is a perspective view of a lens unit showing a first embodiment of the present invention;

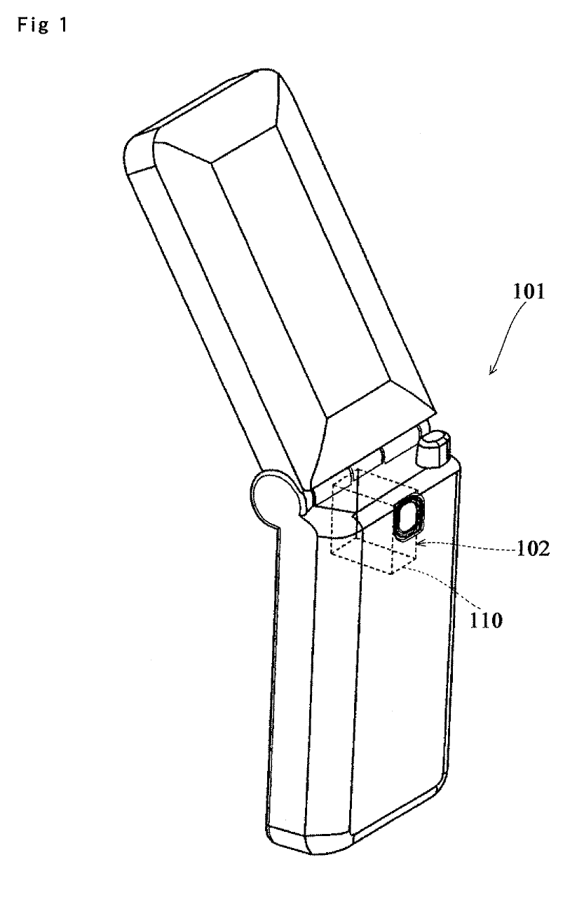

FIG. 2 is a perspective view of the lens unit showing the embodiment of the present invention;

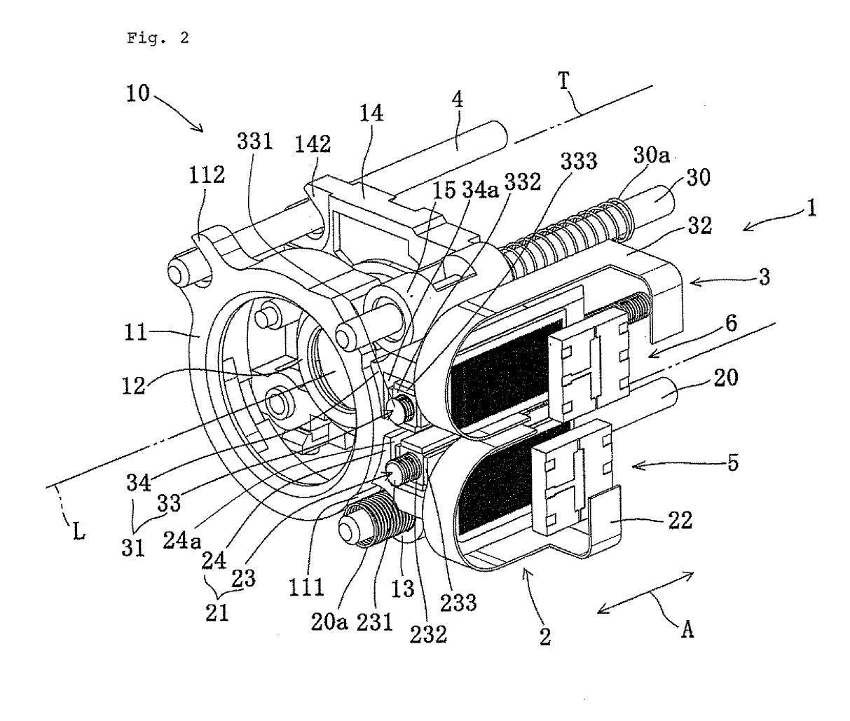

FIG. 3 is a front view of the lens unit showing the embodiment of the present invention; and

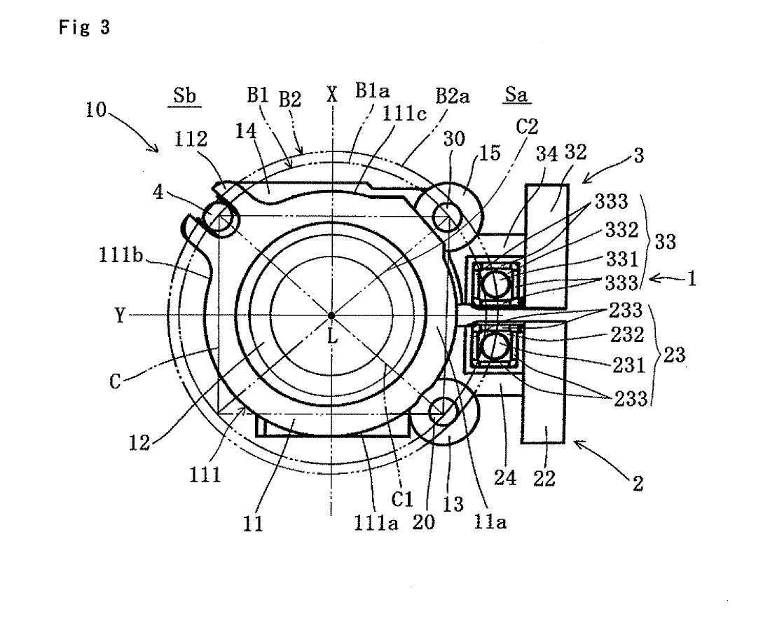

FIG. 4 is a front view of a lens unit showing a second embodiment of the present invention.

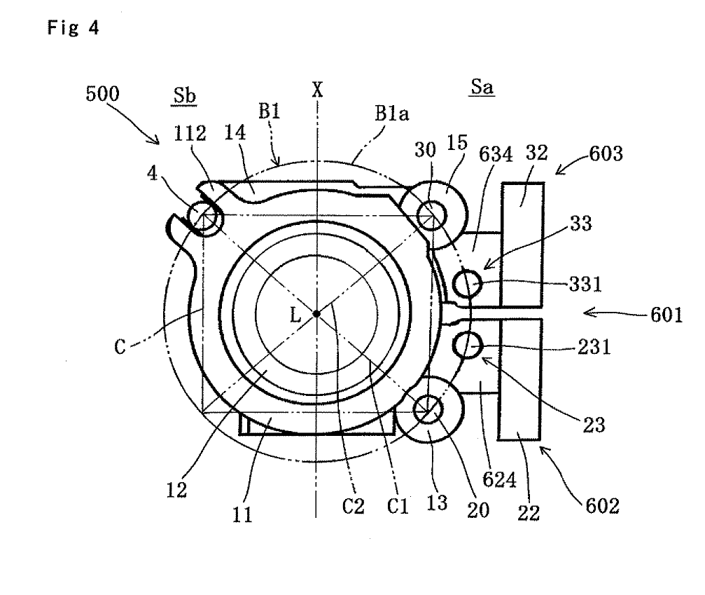

### DESCRIPTION OF SYMBOLS

1 Lens-driving unit
4 Rotation prevention pole
11 First lens-group holding frame
12 Second lens-group holding frame
20 First guide pole
23 First piezo-electric motor
24 First piezo-electric motor holding unit
30 Second guide pole
33 Second piezo-electric motor
34 Second piezo-electric motor holding unit
231 Lead screw
232 Nut
233 Piezo-element
331 Lead screw
332 Nut
333 Piezo-element
601 Lens-driving unit
624 First piezo-electric motor holding unit
634 Second piezo-electric motor holding unit
A Optical axis direction
B1 First virtual circle
B1a Circumferential orbit
C Virtual rectangle
C1 Diagonal
C2 Diagonal
L Optical axis
Sa Right side region of periphery region
X Virtual center line

1-5. (canceled)

6. A lens-driving unit to make slide both a first lens-group holding frame and a second lens-group holding frame constituting an imaging device arranged in series in an optical axis direction along a first guide pole and a second guide pole in the optical axis direction by using a first motor and a second motor respectively,
wherein both the first guide pole and the second guide pole are arranged to be parallel to the optical axis to support the first lens-group holding frame and the second lens-group holding frame able to slide in the optical axis direction respectively,
the first motor and the second motor comprise a lead device which makes move the first lens-group holding frame and the second lens-group holding frame in the optical axis direction respectively, and a piezo-element arranged on the lead device,
a first holding unit is arranged on a periphery of the first lens-group holding frame and the lead device constituting the first motor fixed to the first holding unit is arranged to be parallel to the optical axis, the first lens-group holding frame is constructed able to slide along the first guide pole in the optical axis direction according to motion of the first holding unit in the optical axis direction driven by the first motor,
a second holding unit is arranged on a periphery of the second lens-group holding frame and the lead device constituting the second motor fixed to the second holding unit is arranged to be parallel to the optical axis, the second lens-group holding frame is constructed able to slide along the second guide pole in the optical axis direction according to motion of the second holding unit in the optical axis direction driven by the second motor, and
in the front view of the first lens-group holding frame and the second lens-group holding frame, when the periphery region of the first lens-group holding frame and the second lens-group holding frame is divided into the regions by a virtual center line vertically passing through the periphery region including the optical axis, the lead device constituting the first motor, the lead device constituting the second motor, the first guide pole and the second guide pole are gathered in one side of the regions.

7. The lens-driving unit according to claim 6, wherein the first motor is a first piezo-electric motor and the second motor is a second piezo-electric motor,
the first piezo-electric motor and the second piezo-electric motor are composed of a lead screw, a nut geared with the lead screw and a piezo-element arranged on a periphery of the nut, and the lead device is composed of the lead screw and the nut,
the first holding unit is a first piezo-electric motor holding unit and the second holding unit is a second piezo-electric motor holding unit,
the nut of the first piezo-electric motor is fixed to the first piezo-electric motor holding unit via the piezo-elements in the state that the lead screw of the first piezo-electric motor is arranged to be parallel to the optical axis, and
the nut of the second piezo-electric motor is fixed to the second piezo-electric motor holding unit via the piezo-elements in the state that the lead screw of the second piezo-electric motor is arranged to be parallel to the optical axis.

8. The lens-driving unit according to claim 7, wherein in the front view of the first lens-group holding frame and the second lens-group holding frame, the first guide pole and the second guide pole are arranged at positions on a circumferential orbit of a virtual circle which is virtually set centered on the optical axis around the periphery of the first lens-group holding frame and the second lens-group holding frame where the diagonals of a virtual rectangle whose top line and bottom line intersect the virtual line at right angle and is inscribed in the virtual circle intersect, and the lead screw of the first piezo-electric motor and the lead screw of the second piezo-electric motor are arranged in a central area between the first guide pole and the second guide pole.

9. The lens-driving unit according to claim 8, wherein the lead screw of the first piezo-electric motor and the lead screw of the second piezo-electric motor are arranged on the circumferential orbit of the virtual circle.

10. The lens-driving unit according to claim 6, wherein a rotation prevention pole is arranged to be parallel to the optical axis and common for the first lens-group holding frame and the second lens-group holding frame is disposed in the other region resulted from dividing the periphery region by the virtual center line in the front view of the first lens-group holding frame and the second lens-group holding frame.
